(19) United States
(12) Patent Application Publication
(10) Pub. No.: US 2023/0119784 A1
(43) Pub. Date: Apr. 20, 2023

(54) HYDROGEN AND/OR AMMONIA PRODUCTION PROCESS

(71) Applicant: Reinertsen New Energy AS, Trondheim (NO)

(72) Inventors: Torkild R. Reinertsen, Trondheim (NO); Stein Bernhardsen, Heimdal (NO); Erling Rytter, Trondheim (NO); Dag Schanke, Trondheim (NO); Dag Vareide, Jakobsli (NO); Mohammad Ostadi, Trondheim (NO)

(21) Appl. No.: 17/905,448

(22) PCT Filed: Feb. 23, 2021
(86) PCT No.: PCT/EP2021/054441

§ 371 Date: Sep. 1, 2022

(30) Foreign Application Priority Data
Mar. 6, 2020 (GB) 2003317.1
Jul. 2, 2020 (GB) 2010174.7

(51) Int. Cl. C01B 3/38; C01B 3/48; C01B 3/50; C01B 3/02

(52) U.S. Cl. CPC C01B 3/382; C01B 3/48; C01B 3/505; C01B 3/025; C01B 2203/0233; C01B 2203/0244; C01B 2203/0283; C01B 2203/0405; C01B 2203/043; C01B 2203/046; C01B 2203/0475; C01B 2203/0495; C01B 2203/068; C01B 2203/0844; C01B 2203/142; C01B 2203/146; C01B 2203/148; C01B 2203/1614; C01B 2203/1241; C01B 2203/1258; C01B 2203/0485

(57) ABSTRACT

Disclosed herein is a method of producing hydrogen, the method comprising: receiving a feed gas comprising hydrocarbons; performing one or more reforming processes on the feed gas so as to generate a reformed gas comprising hydrogen and carbon monoxide; performing a water-gas-shift process on the reformed gas so as to generate a shifted gas comprising hydrogen and carbon dioxide; performing a hydrogen separation process and a carbon dioxide separation process on the shifted gas to thereby generate separate streams of hydrogen, carbon dioxide and a rest gas; and the method further comprises recycling at least part of the rest gas by feeding at least part of the rest gas back into one or more of the one or more reforming processes, the water-gas-shift process, the hydrogen separation process and the carbon dioxide separation process; wherein the portion of the rest gas that is recycled is at least 50%, preferably at least 80%, and more preferably at least 90%.

### FIELD

The present disclosure relates to hydrogen and ammonia production processes. Embodiments provide a system for generating syngas and then separating hydrogen from the syngas. The system according to embodiments may use the separated hydrogen to generate ammonia.

### BACKGROUND

It is generally believed that the greenhouse effect and the climate on Earth are closely linked to human-made emissions of carbon dioxide (CO₂). These emissions are primarily formed by combustion of coal and hydrocarbons, i.e. by generation of heat, electric power as well as use in internal combustion engines. A desirable goal is to reduce the emission of CO₂ to the atmosphere. It is known art to reduce the emission of CO₂ from combustion of natural gas, e.g. by gas reforming and shift technology for preparation of a mixture consisting of hydrogen and carbon dioxide. These components are then separated, after which hydrogen may be used in a number of applications, such as electricity generation, heat generation and in different types of transportation. Hydrogen may also be mixed with natural gas to produce hytane, a fuel for domestic and industrial energy users. Carbon dioxide has industrial applications but may also be deposited after compression to a desired pressure. The deposition can be made on the bottom of the sea or in geological reservoirs, often called aquafers. The reservoirs can also contain hydrocarbons.

Hydrogen in the transport sector as fuel for fuel cells is gaining increased attention, and fueling stations for transportation vehicles are being deployed in several areas of the world, notably in the USA, Europe and Japan. Practically all of these fueling stations are based on hydrogen that is made by splitting water through electrolysis and compressed to typically 700 bar. Liquid hydrogen is being considered for heavier transport like ships and trains. Unfortunately, electrolysis has been calculated to be at least twice as costly as producing hydrogen by reforming natural gas. These calculations include costs of separation and liquefaction of coproduced CO₂ and payment of tariffs for deposition of CO₂ in underground reservoirs. Another complicated issue with water electrolysis is calculation of the greenhouse effect, as most electricity is still produced from hydrocarbons with significant emission of CO₂ to the atmosphere. Therefore, producing hydrogen from natural gas with CO₂ storage is a significantly better option.

There is a general need to improve hydrogen production processes.

### SUMMARY OF INVENTION

According to a first aspect of the invention, there is provided a method of producing hydrogen, the method comprising: receiving a feed gas comprising hydrocarbons; performing one or more reforming processes on the feed gas so as to generate a reformed gas comprising hydrogen and carbon monoxide; performing a water-gas-shift process on the reformed gas so as to generate a shifted gas comprising hydrogen and carbon dioxide; performing a hydrogen separation process and a carbon dioxide separation process on the shifted gas to thereby generate separate streams of hydrogen, carbon dioxide and a rest gas; and the method further comprises recycling at least part of the rest gas by feeding at least part of the rest gas back into one or more of the reforming process, the water-gas-shift process, the hydrogen separation process and the carbon dioxide separation process; wherein the portion of the rest gas that is recycled is at least 50%, preferably at least 80%, and more preferably at least 90%.

Preferably, the one or more reforming processes comprise an autothermal reforming process.

Preferably, the one or more reforming processes comprise a partial oxidation reforming process.

Preferably, the reforming process comprises a gas heated reforming process.

Preferably, the reforming process comprises both a gas-heated reforming process and an autothermal reforming process; and heat generated by the autothermal reforming process is supplied to the gas-heated reforming process.

Preferably, the method further comprises: optionally performing a sulfur removal process on the feed gas before performing the reforming process on the feed gas; and optionally performing a pre-reforming process on the feed gas before performing the reforming processes on the feed gas; wherein the pre-reforming process comprises: optionally saturating the feed gas with at least water before performing the pre-reforming processes on the feed gas; and optionally adding hydrogen to the feed gas before performing the pre-reforming processes on the feed gas.

Preferably, the hydrogen separation process comprises: inputting the shifted gas to a hydrogen separator that comprises a Palladium membrane, wherein the hydrogen separator comprises a permeate side of the Palladium membrane and a retentate side of the Palladium membrane, and the shifted gas is input to the retentate side of the Palladium membrane; outputting hydrogen from the permeate side of the Palladium membrane; and outputting a hydrogen-depleted shifted gas from the retentate side of the Palladium membrane.

Preferably, the hydrogen separation process comprises a PSA process.

Preferably, the rest gas that is recycled is fed back into the autothermal reforming process and/or another reforming process, such as a partial oxidation reforming process.

Preferably, the rest gas that is recycled is fed back into the water-gas-shift process.

Preferably, the rest gas that is recycled is fed back into the hydrogen separation process.

Preferably, the feed gas is natural gas.

Preferably, the feed gas is a hydrocarbon-rich gaseous stream from, or within, an oil refinery or a petrochemical plant.

Preferably, the temperature of the gas exiting the gas-heated reforming process is in the range 400-800° C., preferably 450-700° C., more preferably 540-600° C.

Preferably, the autothermal reforming process is supplied with oxygen from an air separation unit.

Preferably, the water-gas-shift process is conducted in one water-gas-shift reactor; wherein, optionally, the water-gas shift reactor is operated at a temperature between about 200 and about 330° C., preferably between about 240 and about 310° C., such as between about 240 and about 270° C. or between about 290 and about 310° C., and/or at about 300° C.; and wherein, optionally, the water-gas-shift process comprises using a Cu-based catalyst.

Preferably, the water-gas-shift process and the hydrogen separation process are operated at about the same temperature.

Preferably, no additional steam is added between the reforming processes and the water-gas-shift process.

Preferably, the method further comprises operating the water-gas shift process so that the CO conversion in the water-gas-shift process is at least 90%, and below 98%, more preferably below 96%.

Preferably, water is separated from hydrogen-depleted shifted gas output from the hydrogen separation process.

Preferably, water is not separated from the shifted gas before the hydrogen separation process.

Preferably, the Palladium membrane is operated at a temperature between 200 and 400° C., preferably between 250 and 350° C., more preferably between 270 and 330° C.

Preferably, the carbon dioxide separation process is conducted cryogenically.

Preferably, the method further comprises generating ammonia in dependence on hydrogen output from the hydrogen separation process and nitrogen output from an air separation unit.

According to second aspect of the present invention, there is provided a hydrogen production plant arranged to perform the method of the first aspect.

According to third aspect of the present invention, there is provided an ammonia production plant arranged to perform the method of the first aspect.

### BRIEF DESCRIPTION OF DRAWINGS

FIG. 1 shows a reforming process comprising a gas-heated reforming process and an autothermal reforming process.

FIG. 2 shows a configuration of a hydrogen production process.

FIG. 3 shows a configuration of a hydrogen production process according to an embodiment.

FIG. 4 shows a configuration of a hydrogen production process according to an embodiment.

FIG. 5 shows a configuration of a hydrogen production process according to an embodiment.

FIG. 6 shows a configuration of a hydrogen production process according to an embodiment.

FIG. 7 shows a configuration of a hydrogen production process according to an embodiment.

FIG. 8 shows a configuration of a hydrogen production process according to an embodiment.

FIG. 9 shows a configuration of a hydrogen production process according to an embodiment.

FIG. 10 comprises Table 1.

FIG. 11 comprises Table 2.

FIG. 12 comprises Table 3.

FIG. 13 comprises Table 4.

FIG. 14 comprises Table 5.

FIG. 15 comprises Table 6.

FIG. 16 shows a configuration of an ammonia production process according to an embodiment.

### DETAILED DESCRIPTION OF EMBODIMENTS

A known method for the production of a CO₂-rich gas stream and a H₂-rich gas stream comprises the following steps:
a) natural gas and water are fed to a reforming reactor and are converted to synthesis gas, also referred to as syngas, under supply of an O₂-containing gas. Syngas mainly comprises H₂ and CO;
b) the gas stream from a) is shifted so as to produce a mixture of H₂ and CO₂ by reaction with H₂O;
c) CO₂ is separated from the gas stream from b) in a CO₂ separation unit;
d) H₂ is separated from the CO₂-depleted gas from c) in a H₂ separation unit.

The above method describes the basic principles behind the production hydrogen from natural gas with separation of hydrogen and CO₂.

Known techniques combust the remaining gas after separation of CO₂ and H₂ as fuel. If a relatively high percentage of hydrogen has not been separated, then a significant amount of hydrogen will be wasted in this fuel. Furthermore, the combustion of any accompanying carbon containing species in the fuel produces uncaptured CO₂.

Most hydrogen producing processes from natural gas known in the art rely on the use of a steam reformer, and in some instances on an autothermal reformer (ATR), i.e. using an autothermal reactor, or a partial oxidation reactor (PDX). However, use of a gas-heated-reformer (GHR) in combination with an autothermal reformer is considerably more energy efficient.

Production and perspectives on syngas production has been described by J. R. Rostrup-Nielsen in Catalysis Today, volume 18, pages 305-324, 1993, and in volume 71, pages 243-247, 2002. There are several types of reformers for production of synthesis gas comprising steam reforming, autothermal reforming and partial oxidation. There are methods for producing synthesis gas by a combination of steam reforming and autothermal reforming. Combined reforming comprises steam reforming and autothermal reforming, normally in series. Gas heated reforming (GHR) utilizes hot gas, e.g. off-gas from autothermal reforming, to provide heat for reforming of a feed gas. GHR is described in a paper by K. J. Elkins et al. entitled “The ICI Gas-Heated Reformer (GHR) System” presented at the Nitrogen '91 International Conference, Copenhagen, June 1992. Separation of CO₂ is frequently done by an amine washing process, a carbonate process, and sometimes by using a physical sorbent like methanol or ethers; or simply by washing with water.

Hydrogen may be separated from a hydrogen containing gas mixture by use of a pressure swing absorption/adsorption (PSA) processor. In some implementations of PSA processes by a PSA reactor, the PSA reactor is a large and costly part of the hydrogen plant. PSA processes may also result in CO₂ being released at low pressure, e.g. atmospheric pressure, and so there is a subsequent need for compression and cooling. Still, it can be feasible to use PSA for some hydrogen production plants.

Embodiments provide new and particularly advantageous implementations of systems for producing hydrogen from natural gas. Hydrogen production may be the main purpose of the system. However, embodiments also include using at least some of the hydrogen, or all the hydrogen, to produce ammonia. Ammonia is an alternative energy carrier to compressed or liquefied hydrogen. In addition to the production of fertilizers and some chemicals, ammonia may be used as fuel in energy, transportation, maritime and offshore markets.

Embodiments also provide a high carbon capture efficiency that may be at least 90% of the carbon in the feed gas, and preferably at least 97%.

Although embodiments may separate CO₂ by using an amine washing process, or other process, embodiments preferably use cryogenic separation to separate CO₂. That is to say, the gas steam is cooled to a temperature, and at a pressure, where CO₂ is liquefied.

Cryogenic separation of CO₂ has in the known art been assumed to be disadvantageous as a smaller fraction of CO₂ is separated. However, embodiments avoid this disadvantage by providing novel process design. CO₂ is obtained directly in a liquid form, i.e. ready for transportation to a deposition site.

Embodiments advantageously re-use the remaining gas after separation of CO₂ and H₂ in the hydrogen production system. This improves the carbon capture efficiency of the system.

Embodiments include using a Palladium membrane (Pd-membrane) to separate hydrogen from the reformed natural gas; or more generally from a reformed gas containing hydrocarbons. One advantage is that hydrogen is obtained with high purity; that may be greater than 99% and is often greater than 99.9%. Another advantage is that the gas containing CO₂ that does not pass through the membrane, which is referred to as the retentate, is at an elevated pressure, typically above 10 bar, more typically between 20 and 40 bar, but sometimes even at pressures up to 100 bar. It is even preferred that the Pd-membrane operates at an elevated temperature; 200-400° C., or in a narrower range above or around 300° C., so that it is well suited for operation down-stream of the water-gas-shift (WGS) reactor or reactors.

Embodiments also include using a PSA process, or PSA processes, to separate hydrogen from the reformed natural gas; or more generally from a reformed gas containing hydrocarbons.

Embodiments include receiving a supply of natural gas, or more generally a hydrocarbon containing gas from any source. The natural gas may be cleaned and pre-treated in a suitable manner so that the gas feed mainly comprises methane after treatment. Such cleaning typically comprises sulfur removal, for example by one or more ZnO absorbers. Sometimes heavy metals, typically Hg, are also removed. The pre-treatment may also comprise a pre-reforming process whereby higher hydrocarbons, such as ethane, are converted by steam to methane and CO₂.

The reforming process according to embodiments may take place at a pressure within the interval 10 to 200 bar.

The water-gas shift reaction according to embodiments may take place in one or more shift reactors. Steam may be supplied to the shift reactor, but the shift reactor may also be operated without supply of steam as steam already may have been introduced into the reformer. At the outlet of the shift reactor, the carbon content may comprise CO₂ and methane. CO₂ may be about 2% to about 5% by volume or higher. Methane may be about 2% to about 5% by volume or higher.

The following chemical reactions may take place during production of synthesis gas and hydrogen by reforming of natural gas:

CH₄+H₂O [symbol] CO+3H₂ 1. Steam reforming

CH₄+½O₂ [symbol] CO+2H₂ 2. Partial oxidation

CO+H₂O [symbol] CO₂+H₂ 3. Shift reaction

The heat of reaction for the strongly endothermic steam reforming can be provided either by external heating, as in a steam reformer, or by partial oxidation in an autothermal reformer.

In a steam reformer (SR) natural gas (i.e. methane) is converted in a tube reactor at high temperature and relatively low pressure. A steam reformer consists of many reactor tubes, e.g. 200-250 tubes with typical lengths of 12-13 meters, inside diameter of about 10 cm and an outside diameter of about 12 cm. This is a space demanding unit with a length of 30-50 meters, width of 10-12 meters and a height of 15-20 meters. Conventional steam reformers are operated in the pressure range from 15 to 30 bar. The outlet temperature of the gas from a conventional steam reformer is approximately 950° C. The energy which is used to carry out the endothermic reactions is supplied by external firing/heating (top-, side-, bottom- or terrace-fired). The ratio between steam and carbon is from 2.5 to 3.5, and the ratio between hydrogen and carbon monoxide in the produced stream is from 2.7 to 3.0. Synthesis gas produced from a steam reformer may contain approximately 3% methane by volume.

Alternatively, the reforming of natural gas (equation 1 and 2 above) can take place in an autothermal reformer (ATR). In an ATR, natural gas (methane) is fed together with oxygen or air into a combustion chamber. The energy which is required to operate the endothermic steam reforming reactions is provided by the exothermic reactions between hydrocarbons and/or hydrogen and oxygen. The temperature in the combustion chamber can reach more than 2000° C. After the combustion chamber the reactions may be driven to equilibrium over a catalyst bed before the synthesis gas leaves the reactor at approximately 1000-1050° C. The size of such a unit could be a height of 10-15 meters and a diameter of 5-6 meters. A typical ratio of steam:carbon in the output gas is from 0.6 to 1.4. The ratio of hydrogen to carbon monoxide in the output gas is lower than 2. Typical methane slip, i.e. amount of unconverted methane, is 1-2% by volume in the product stream. The ATR can be operated at higher pressure than the SR.

A further option for reforming natural gas is a partial oxidation reactor (PDX) which also is an autothermal reformer except that the unit does not comprise a catalyst bed. The exit temperature for a PDX is higher than for a typical ATR, sometimes significantly higher and it may be above 1200° C. PDX is often characterized by no steam added to the feed. A catalyst might be included, thus defining a catalytic partial oxidation (CPDX) reactor.

Reforming of natural gas can also be made by combined reforming (CR) which is a combination of a steam reformer (SR) and an autothermal reformer (ATR). A combination of SR and ATR makes it possible to adjust the composition out of the reformer unit by regulating the efforts on the two reformers. In combined reforming, SR is operated at milder conditions (i.e. lower outlet temperature), which leads to a high methane slip. The residual methane is then reacted in the ATR. The ratio of steam:carbon is in the area 1.8-2.4, with a ratio of hydrogen to carbon monoxide in the product gas higher than 2.

From the above, it is clear that the conventional reformer unit has a very large footprint (SR), and that the exit gas is at a high temperature, typically 950-1100° C. Conventionally, the exit gas is cooled down rapidly using a waste-heat-boiler (WHB) that produces steam. Rapid cooling and using tubes with boiling water are important to be able to control material corrosion by metal dusting. It has been found, however, that a more efficient process is experienced if the hot output gas is used to reform part of the natural gas before it enters the autothermal reformer. This combination of ATR with oxygen and a gas-heated-reformer (GHR) has been tested in a demonstration unit for production of methanol. This development originates in ICI in the 1980s to completely remove the traditional steam reformer in their Leading Concept Methanol (LCM) process.

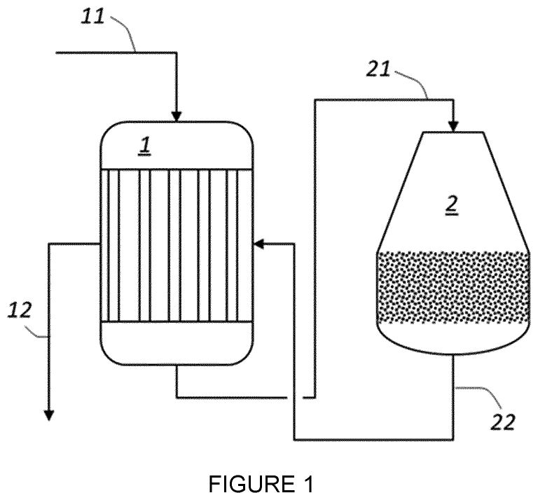

FIG. 1 shows an efficient reforming process that may be used in embodiments. The hot exit gas from the reformer is used to reform part of the natural gas before it enters the autothermal reformer. Instead of burning fuel gas to provide the heat for the reforming reactions, the hot, autothermally reformed gas 22 is used to heat the catalyst tubes in a GHR 1. The feed gas 11 first passes through the catalyst in the GHR 1, then the partially reformed gas in stream 21 passes through the ATR 2, and finally the reformed gas in stream 22 passes through the heating side of the GHR 1 to provide the heat for the initial reaction. Thereby the exit temperature of the syngas 12 is reduced significantly to the range 500-600° C. and needs only moderate further cooling before the water-gas-shift process (WGS).

Although embodiments include the reforming process shown in FIG. 1, embodiments also include alternatively using any other type of reforming process. For example, embodiments include only using an autothermal reformer or only using a gas-heated-reformer.

After reforming of the natural gas and cooling, the gas mixture is shifted. The gas mixture from the reformer reactor contains mainly the gas components CO, H₂, H₂O, CO₂ and some CH₄. Between these components there is an equilibrium relation given by the stoichiometric equation:

CO+H₂O [symbol] CO₂+H₂

This reaction is called the water-gas-shift (WGS) reaction, and by operating a shift reactor at certain conditions the equilibrium can be forced to the right and a gas mixture is obtained which is rich in hydrogen and carbon dioxide, and where the concentration of carbon monoxide is low. Sufficient reaction velocity is provided by use of suitable catalysts, and in processes where a high degree of reaction of CO is desirable (e.g. ammonia synthesis) two fixed bed reactors may be used in series, a high temperature shift reactor and a low temperature shift reactor, respectively. Two steps are chosen because the equilibrium is favored by low temperature, whereas the reaction velocity is favored by high temperature. By selecting two reactors working in series, a smaller total reactor volume is achieved. The process is nearly pressure independent and normally the same pressure as in the reformer is used. Typical temperature out of the first reactor is 420° C. and out of the second reactor 230° C. The catalyst in the first step may be based on chromium/iron, whereas the catalyst in the second step may be a copper/zinc catalyst. In the shift unit CO and H₂O are reacted to form CO₂ and H₂, and in known techniques it is often a requirement that the mentioned reaction is driven to the right to the highest possible degree, so that as little CO as possible is present in the gas mixture exiting the shift unit. A low content of CO in the mentioned gas mixture again may give a high purity of the H₂-rich gas stream out of the separation unit.

In known techniques the shift reactor is operated so that the ratio H₂O:CO to the shift reactor is high, e.g. equal to 10:1, so that there is a high conversion of CO.

Embodiments may differ from such techniques by optimizing the processes in a WGS reactor in conjunction with a hydrogen separation processes by a Palladium membrane. The efficiency of a Pd membrane may be improved by operating at a certain elevated temperature. Preferably, only a high- or medium-temperature WGS is therefore applied before the membrane. A low-temperature WGS may also be used after the membrane and the shifted gas partly recycled, i.e. fed back into one of the earlier processes in the hydrogen production process.

In a preferred embodiment, the temperature of the WGS process is determined in dependence on an operating condition of the Pd-membrane. For example, the temperature of the WGS process may be set substantially at the operating condition of the Pd-membrane, e.g. about 300° C., thereby avoiding any need for heat exchange between the two units. It is not necessary for the WGS process to be operated in a way that maximizes the conversion of CO because the rest gas is recycled back into the earlier processes. Embodiments include no additional steam being added before the WGS reactor. When the Pd-membrane is operated at about 300° C., a Cu-based catalyst may be used.

If a different to Pd-membrane hydrogen separation process is used, like PSA, it still might be feasible to operate only one WGS reactor, e.g., an isothermal shift reactor. Ultra-high conversion of CO is not always needed, and can be rectified by recycle of rest gas.

Gases in the mixture after the shift reactor, or the shift reactors, can be separated more or less completely based on the different properties of the gas molecules. The most common techniques are absorption, adsorption and cryogenic distillation. CO₂ is an acid gas, and the most widely used method to separate the mentioned gas from other non-acid gas molecules is absorption. During absorption the different chemical properties of the gas molecules are utilized. By contacting the gas mixture with a basic liquid, the acid gases will to a high degree be dissolved in the liquid. The liquid is separated from the gas and the absorbed gas can then be set free either by altering the composition of the liquid or by altering pressure and/or temperature. For separation of CO₂, aqueous solutions of alcoholamines can be used. The absorption takes place at a relatively low temperature and a high pressure, while stripping of the gas from the liquid is carried out at a relatively high temperature and low pressure. To liberate CO₂ from the amine phase in the stripping unit, stripping steam is usually used. If the partial pressure of CO₂ in the gas into the absorber is high, e.g. higher than 15 bar, it is possible to obtain high concentrations in the amine phase, and a large part of absorbed CO₂ can be set free in the stripping unit at elevated pressure, e.g. 5-8 bar. Other absorption technologies rely on alternative physical liquid absorbents like methanol at reduced temperature.

Embodiments preferably separate hydrogen from the gas output from the WGS reactor using a membrane. In particular, a Pd-film membrane may be used. By the use of one or more semipermeable or dense membrane units, molecules of different size and different properties can be made to permeate the membrane at different velocities. This principle can be utilized to separate gases. For the gas mixture from the WGS reactor, membranes can be selected where H₂ permeates rapidly, whereas CO₂ permeates slowly or not at all, so that separation of the different gas components is achieved. The membrane may be a Palladium membrane.

The driving force over the membrane is the difference in partial pressure, i.e. of hydrogen between the process gas (which is the received gas on the retentate side of the membrane) and gas on the permeate side of the membrane. As hydrogen in many cases is required at an elevated pressure, a way to secure partial pressure difference is to use a sweep gas of steam at the permeate side and then condense out water afterwards, leaving hydrogen at a pressure comparable to the process gas. Although embodiments include using a sweep gas, this is optional and embodiments also include not using a sweep gas.

Embodiments may alternatively use a combination of solid membranes and liquid membranes through which there is a rapid permeation of CO₂, while H₂ is kept back. Embodiments may alternatively use PSA to separate hydrogen from the gas output from the WGS reactor. PSA is a technology used to separate some gas species from a mixture of gases under pressure according to the species' molecular characteristics and affinity for an adsorbent material. It operates at near-ambient temperatures and differs significantly from cryogenic distillation techniques of gas separation. Specific adsorptive materials (e.g., zeolites, activated carbon, molecular sieves, etc.) are used as a trap, preferentially adsorbing the target gas species at high pressure. The process then swings to low pressure to desorb the adsorbed material. In the present mixture of gases, CO, CO₂ and CH₄ are adsorbed, letting the hydrogen pass through at process pressure. Not to overload the adsorbent, water is condensed before the PSA unit. Alternatively, the temperature can swing instead of the pressure.

Capturing CO₂ by refrigeration is a cost and energy efficient method compared to other technologies. In known techniques, electricity may be used to drive the compressors. The main challenge has been that only in the order of 90% of CO₂ is captured this way, or perhaps 93% by optimizing conditions. In addition, there are some carbon losses from unconverted CO and CH₄ and these reduce the overall carbon capture to 90% or below. Specific advantages of using cryogenic CO₂ separation are that the product is directly in the liquid form needed for deposition and no additional compression is required.

Embodiments include separating out CO₂ and then depositing the separated CO₂. Large amounts of CO₂ can be deposited according to various methods, such as deposition in very deep oceans, deposition in deep water geological reservoirs and deposition in oil reservoirs wherein the gas at the same time functions as drive agent for enhanced oil recovery. The two last mentioned storage methods are operated commercially. In these storage forms the CO₂ gas has to be brought to high pressure and in liquid form for transport in pipelines to a deposition well and further to injection. The injection pressure will vary, but could be in the range 50 to 300 bar. If the CO₂ gas can be separated from the H₂/CO₂ mixture at an elevated pressure, significant compression work can be avoided.

Embodiments may allow a selection to be made between collecting hydrogen and CO₂ at the high (process) pressure. A hydrogen pressure requirement varies with application, but high pressure or liquid hydrogen, is needed for storage and in transportation applications. As it is more demanding to pressurize hydrogen than CO₂, separation technologies that provide hydrogen at high pressure are sometimes preferred. This benefit can, however, be outweighed by the efficiency of a hydrogen-permeable membrane.

Embodiments include using an air separation unit (ASU) to generate oxygen. The oxygen may be supplied to an autothermal reactor, ATR, or a partial oxidation reactor (PDX), used in the reforming process. The ASU may cryogenically separate air into oxygen and a gas mixture that mostly comprises nitrogen. Embodiments include using the nitrogen, from the ASU, and hydrogen, from the membrane separator, to generate ammonia.

Combining nitrogen with hydrogen allows production of ammonia, NH₃, according to the reaction:

N₂+3H₂→2NH₃

Ammonia can be used as an environmentally friendly fuel as long as any CO₂ generated during production is captured. The benefits of using ammonia include ease of transportation and handling. Liquid ammonia can be stored in vessels at about 17 bar.

The ammonia process is favored by high pressures, and an elevated temperature is needed for sufficient reaction rate.

A known production technique of ammonia is from natural gas, or sometimes from higher hydrocarbons, by reforming the gas to syngas that is shifted to mostly hydrogen and CO₂. Using air in the process stream, like applying an ASU, gives a mixture of hydrogen, nitrogen, water and CO₂ after shift conversion. The shift reaction is frequently carried out in two steps, high-temperature and low-temperature shift, to convert CO to low levels. Before the ammonia synthesis, water is knocked out and CO₂ removed by elaborate means. Further, residual CO and CO₂ has to be removed as they are poisons for the catalyst, and this is done by methanation;

CO+3H₂→CH₄+H₂O

CO₂+4H₂→CH₄+2H₂O

The ammonia synthesis loop is also known as Haber-Bosch synthesis. The reaction is run over a catalyst that typically is promoted magnetite. Single pass conversion over the catalyst is around or below 20% and, therefore, significant recycle is required. The pressure is in the range 60-200 bar depending on process design. This is significantly higher than reforming and shifting natural gas that takes place in the pressure range 20-35 bar. On the other hand, the reaction pressure to make ammonia is significantly lower than the 300-700 bar required for hydrogen as energy carrier. Reaction temperature is ca. 450° C. There have been many types of design of ammonia plants during the last 60 years. One option that has been explored is to produce hydrogen from steam reforming combined with PSA, and combined this hydrogen with nitrogen from an ASU-unit. Such a plant, however, is not favorably designed for separating a pure CO₂-stream for storage.

Embodiments are described in more detail by the following examples of embodiments and figures.

Process simulations using the program UniSim are based on natural gas with molar composition 88.8% methane, 5.6% ethane, 2.0% propane, 1.6% higher hydrocarbons, 1.5% CO₂ and 0.6% nitrogen. The gas is delivered at 48 barg and 400° C., and after sulfur removal. The natural gas flow is 4625 kg/h; 246 kmol/h. Hydrogen specification is >99.97 mol % for fuel cells, and specification for CO₂ is dry at >95 mol %. Oxygen is supplied at 40 barg and 20° C.

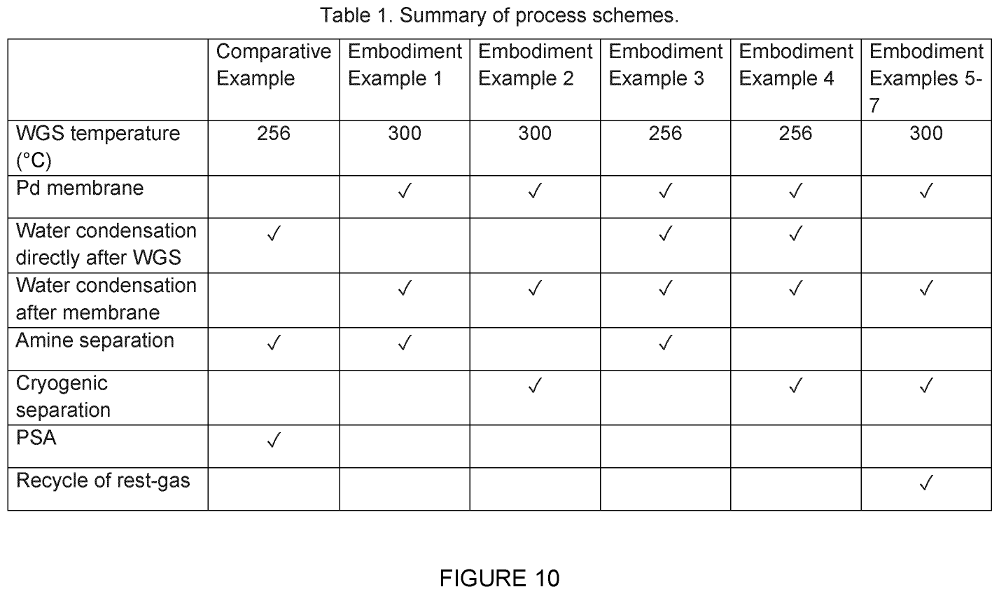

A number of process schemes are analyzed. These include one comparative example and a number of implementations of embodiments, four of which are summarized in Table 1 in FIG. 10. The schemes vary in WGS temperature, use of Pd-membrane or PSA for hydrogen separation, use of amine solvents or cryogenic CO₂ separation, as well as the position of water condensation.

The membrane may be always operated at a preferable temperature for permeation of hydrogen through the membrane. For example, the membrane may be operated at 300° C. However, the WGS may be operated at 256° C. for highest CO conversion, but at 300° C. when the shifted gas is directly introduced to the membrane; i.e. without any heat exchange and water condensation.

The conditions of Embodiment Example 2 are applied in Embodiment Examples 5-7, where recycle of rest gas is used.

The following reasonable assumptions are made, but without fixing these conditions: in amine cases, it is assumed that 100% of inlet CO₂ is removed by the unit; in membrane cases, 93% H₂ separation is assumed; produced H₂ from the membrane unit is at 3 bar and compressed to 350 bar for export; the final CO₂ stream is delivered at −26.2° C. at 16 bar. It is understood that the applied conditions are reasonable for comparing different process schemes, but that a variety of other conditions can be used; e.g. for different natural gas compositions, requirements for delivery of hydrogen and CO₂, and site specific conditions like possibilities for integration with other process units and the availability of electricity from the grid.

### Comparative Example

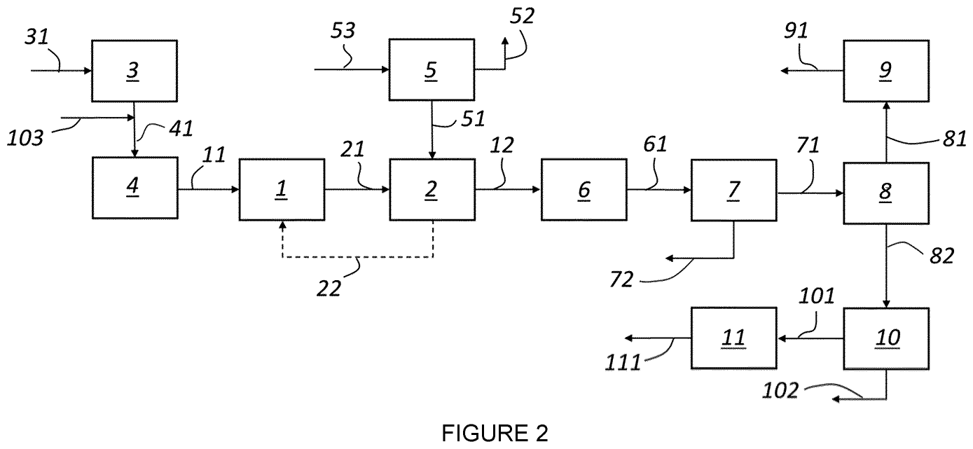

FIG. 2 is a process flow sheet showing production of hydrogen and CO₂ by combination of ATR 2 and GHR 1 according to a comparative example to embodiments.

The natural gas 31 is pretreated in unit 3 that comprises sulfur removal followed by saturation with water. A small portion of the hydrogen stream 101 is optionally added to the pretreated natural gas 41 as stream 103 and fed to the optional pre-reformer 4. The syngas production, by the ATR 2 and GHR 1, is as described in FIG. 1 with units with corresponding reference signs. The heat recycle 22 is the exit gas from the ATR used to heat the GHR. Oxygen 51 from an air separation unit (ASU) 5 is added to the ATR 2. The ASU separates cryogenically air 53 into oxygen 51 and nitrogen 52, sometimes also producing noble gases like argon. It should be understood that embodiments include any other means for producing oxygen, or air enriched in oxygen, such as by using vacuum or pressure swing adsorption, or by using a membrane.

The produced syngas 12 is shifted to increase the content of hydrogen and CO₂ in one or more shift reactors 6, i.e. water-gas-shift reactor(s) 6, to produce the shifted gas 61. Steam may be added to the gas mixture before the gas mixture is input into the shift reactor(s) 6. The addition of steam increases the efficiency of the shift reaction. The shifted gas 61 is subsequently cooled in the condenser 7 to remove its water content 72, thus obtaining dry shifted syngas 71. Amine type separation process 8 separates CO₂ 81 from the shifted gas, and the CO₂ 81 is then compressed 9 and liquefied. The produced CO₂ 91 may be stored at site, shipped for permanent storage or directly injected into a geological formation for storage. Hydrogen 101 is separated in the process 10 by the known technique of pressure-swing absorption/adsorption (PSA), that separates the hydrogen from the gas 82 that has already been depleted of CO₂ by the process 8. The separate outputs from the process 10 are hydrogen 101 and a rest gas 102. The rest gas 102 contains remnants of CO and CH₄ together with unseparated CO₂ and hydrogen. The energy in the rest gas is utilized for fuel in fired heater(s) for preheating of feed gases natural gas and water/steam. Finally, the produced hydrogen 101 is compressed 11 to give hydrogen 111 at 340 bar.

The simulations show that production of 100 kNm³/hr hydrogen requires 35.7 kNm³/hr of NG and 16.7 kNm³/hr of oxygen. 622 tons of CO₂ is captured each year, assuming that the PSA rest gas 102 is used for combustion and the exhaust gas CO₂ emitted to the atmosphere. This gives a CO₂ capture efficiency of 95.4%. Electric power demand at 18.5 MW for compressors is delivered as renewable energy. Energy efficiency from natural gas to hydrogen is 80.4% based on lower heating values.

### Embodiment Example 1

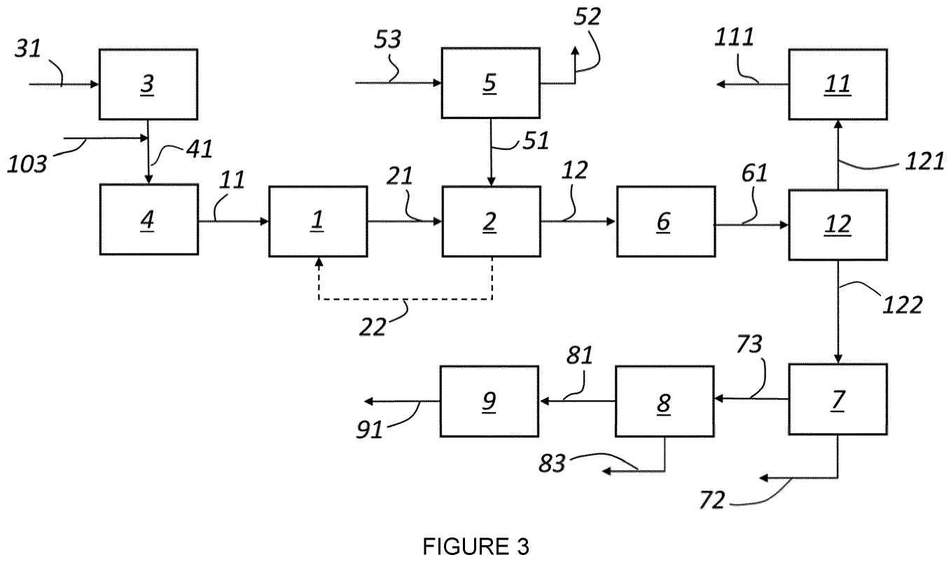

FIG. 3 shows a method for production of hydrogen from natural gas with separation of CO₂ according to embodiment example 1. The syngas production, by the ATR 2, GHR 1 and ASU 5, and natural gas treatment by removing sulfur 3 and pre-reforming 4, and water-gas shift 6, may be as described in FIGS. 1 and 2 with units with corresponding reference signs. Further, compression of hydrogen 11 and CO₂ 9 may be as described in FIG. 2 with corresponding reference signs.

The present embodiment differs from the above-provided comparative example in that hydrogen separation is performed before CO₂ separation. After the WGS process, the shifted gas enters a hydrogen separation vessel that comprises a Pd-membrane 12. The hydrogen separation vessel may receive the output gas from the WGS reactor on the retentate side of the Pd-membrane. Hydrogen passes through the Pd-membrane to reach a permeate side of the Pd-membrane. The hydrogen on the permeate side of the Pd-membrane is output as stream 121. The gas stream output from the retentate side of the Pd-membrane is hydrogen-depleted gas 122.

The hydrogen stream 121 is sent to compressor 11 while the hydrogen-depleted gas stream 122 is depleted of water 72 in the condenser 7. The dried gas 73 is then input into the amine separator 8 that outputs CO₂ stream 81 and a rest gas 83. CO₂ stream 81 is compressed 9, and the CO₂ depleted rest gas 83 may be used for providing energy in fired heater(s).

Advantageously, the use of a Pd-membrane separator for separating hydrogen as the subsequent process to the WGS process allows the hydrogen separation process to be performed particularly efficiently and effectively. In particular, the temperature and/or pressure conditions in the WGS reactor may be selected in order to substantially optimize the operating conditions of the membrane separator (e.g. to maximize the separation of hydrogen in the membrane separator).

### Embodiment Example 2

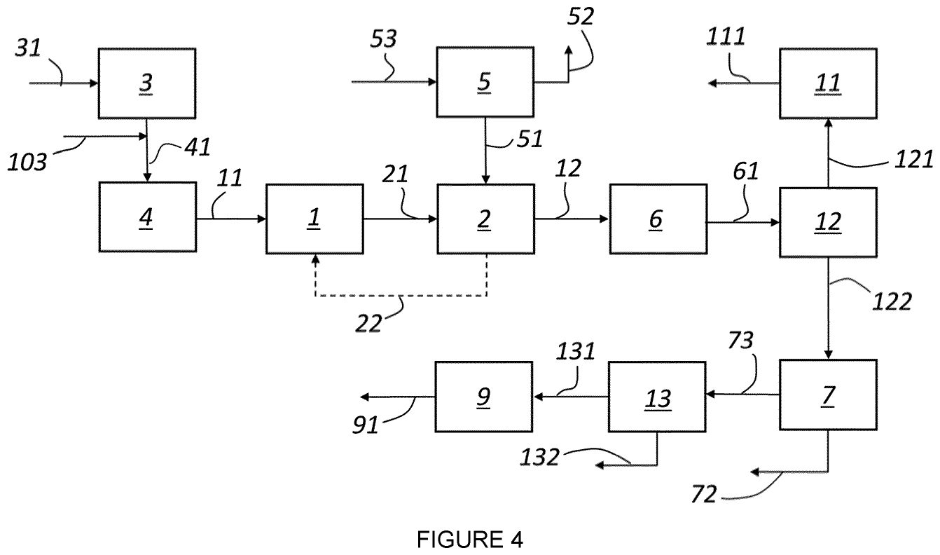

FIG. 4 shows a method for production of hydrogen from natural gas with separation of CO₂ according to embodiment example 2. The syngas production, by the ATR 2, GHR 1 and ASU 5, and natural gas treatment by removing sulfur 3 and pre-reforming 4, and water-gas shift 6, may be as described in FIGS. 1 and 2 with units with corresponding reference signs. Further, compression of hydrogen 11 and CO₂ 9 may be as described in FIG. 2 with corresponding reference signs. Separation of hydrogen by Pd-membrane and water condensation 7 may be as described with reference to FIG. 3 with corresponding reference signs.

A difference between embodiment example 2 and embodiment example 1 is that the amine unit 8 of embodiment example 1 is replaced with cryogenic separation 13 of CO₂ 131 from the dried gas 73, giving the rest gas 132 for use in fired heater(s).

### Embodiment Example 3

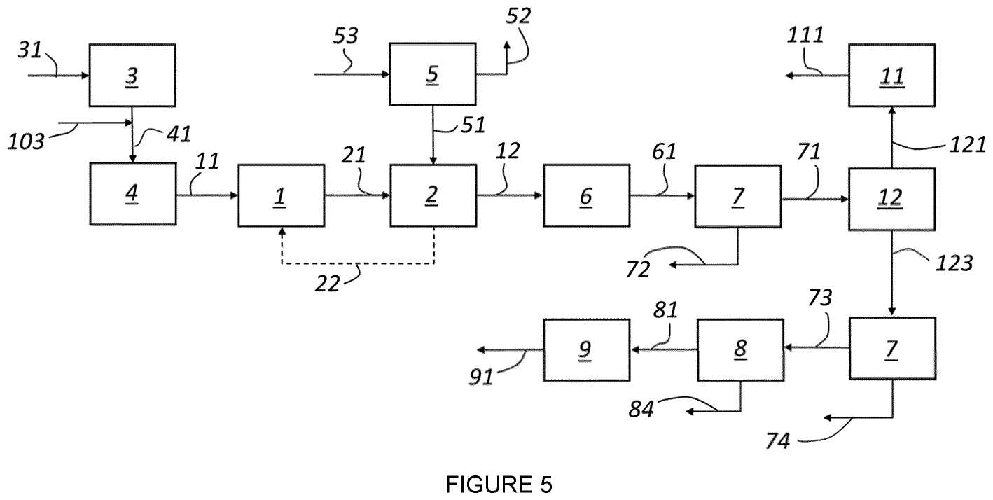

FIG. 5 shows a method for production of hydrogen from natural gas with separation of CO₂ according to embodiment example 3. The syngas production, by the ATR 2, GHR 1 and ASU 5, and natural gas treatment by removing sulfur 3 and pre-reforming 4, and water-gas shift 6, may be as described in FIGS. 1 and 2 with units with corresponding reference signs. Further, compression of hydrogen 11 and CO₂ 9 may be as described in FIG. 2 with corresponding reference signs. This embodiment contains two condensers 7 for depleting water, streams 72 and 74, respectively, placed before and after the Pd-membrane 12. Such configuration allows the shifted gas 61 to be heated to the ideal temperature before entering the membrane unit as stream 71. In addition, reducing the water concentration before the membrane unit may advantageously increase the hydrogen concentration and may protect materials in the membrane unit.

The use of water condenser 7 on the gas output from the retentate side of the membrane separator 12 is optional.

CO₂ 81 is removed in an amine unit 8 leaving an energy rich rest gas 84.

### Embodiment Example 4

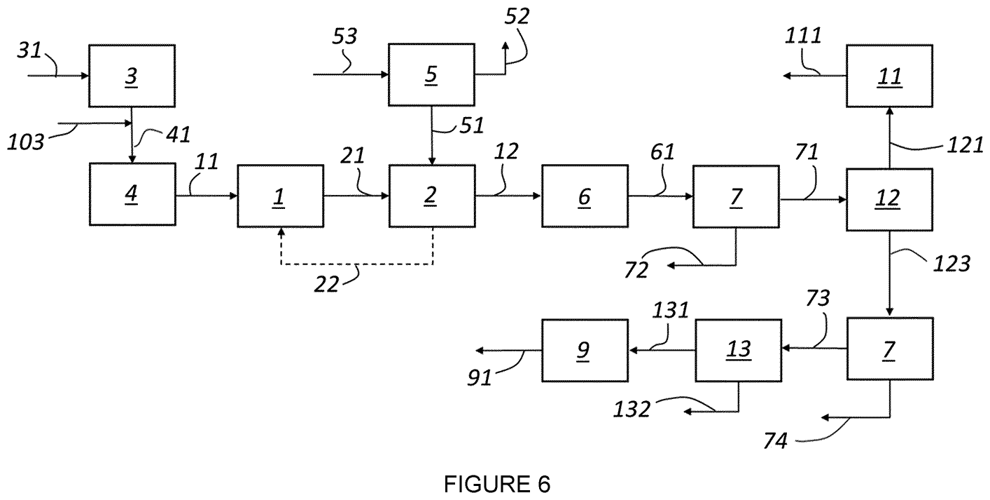

FIG. 6 shows a method for production of hydrogen from natural gas with separation of CO₂ according to embodiment example 4. The syngas production, by the ATR 2, GHR 1 and ASU 5, and natural gas treatment by removing sulfur 3 and pre-reforming 4, and water-gas shift 6, may be as described in FIGS. 1 and 2 with units with corresponding reference signs. Further, compression of hydrogen 11 and CO₂ 9 may be as described in FIG. 2 with corresponding reference signs.

The present embodiment contains two condensers 7 for depleting water, streams 72 and 74, respectively, placed before and after the Pd-membrane 12. Such a configuration allows the shifted gas 61 to be heated to the ideal temperature before entering the membrane unit as stream 71.

CO₂ 131 is removed in the cryogenic unit 13 leaving an energy rich rest gas 132.

A comparison of the comparative example and embodiment examples 1-4 is provided below.

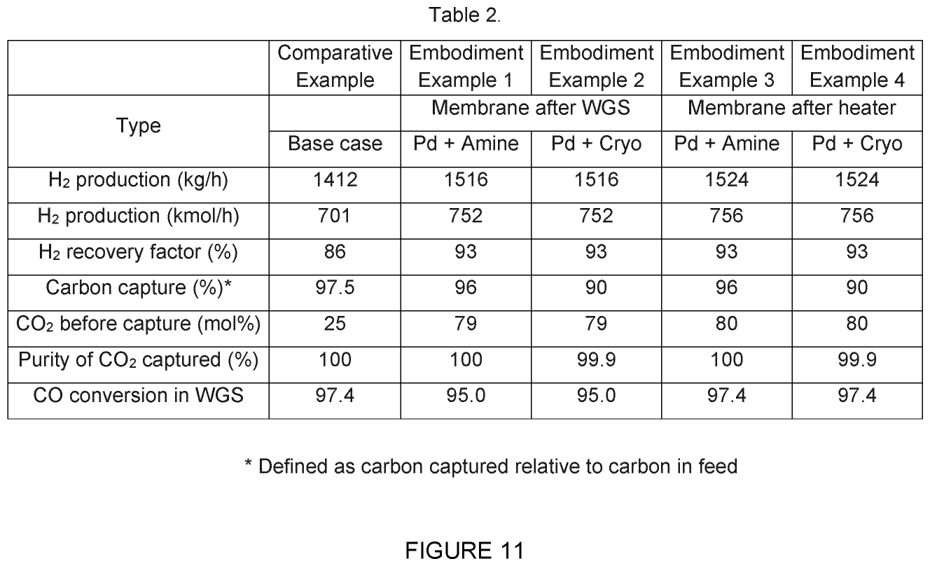

A comparison of performance of the comparative example and embodiment examples 1, 2, 3 and 4 is listed in Table 2 in FIG. 11. There are, in addition, differences in investment and operating costs (i.e. CAPEX and OPEX). As to the investment costs, prices from vendors show that for hydrogen separation, PSA is considerably more costly than using a Pd-membrane, and that for CO₂ separation, using amine is significantly more costly than cryogenic separation. In addition, the footprints of PSA and amine are much larger than for Pd-membrane and cryogenic CO₂ separation.

Using a Pd-membrane, as in embodiment examples 1-4, is advantageous due to lower cost, smaller footprint and a higher hydrogen recovery factor than the comparative example. Note from the H₂ recovery factor that only 7% of the hydrogen in the shifted gas is lost in embodiment examples 1-4, compared to 14% in the comparative example. The percentage of carbon captured is above the 95% mark for embodiment examples 1 and 3, which is fully acceptable for most projects, although these still use amine separation of CO₂. The amine separation in these two embodiments is, however, significantly simpler than in the comparative example, due to the more than 3-fold higher concentration of CO₂ in the inlet gas. Other factors to be considered are the conversion in the WGS (see Table 2 in FIG. 11), and differences in how water is condensed (see Table 1 in FIG. 10 as well as the figures).

Known techniques are based on the assumption that a high conversion of CO in the WGS reactor results in better system performance with regard to hydrogen and CO₂ recovery. However, test of embodiments show that the performance of the separation technologies is more dominant on the overall system performance. Accordingly, operating the WGS at 300° C. is advantageous.

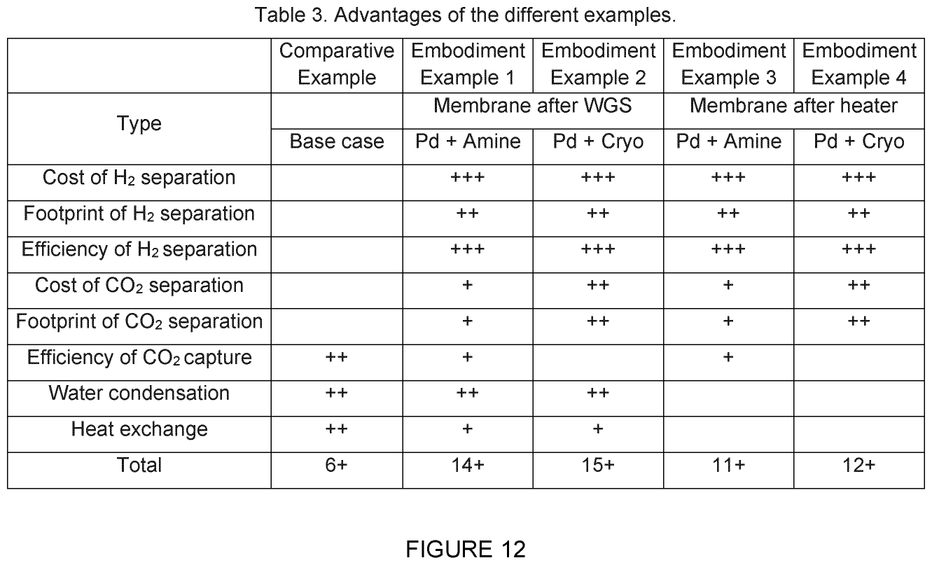

There is no condensation of water and heat exchange after WGS and before the Pd-membrane in Embodiment Examples 1 and 2, in contrast to Embodiment Examples 3 and 4. The discussed advantages are summarized in Table 3 in FIG. 12. It follows that using a Pd-membrane is preferable compared the comparative example, and that there is no need to adjust temperature and knock out water directly after WGS.

### Embodiment Examples 5-7

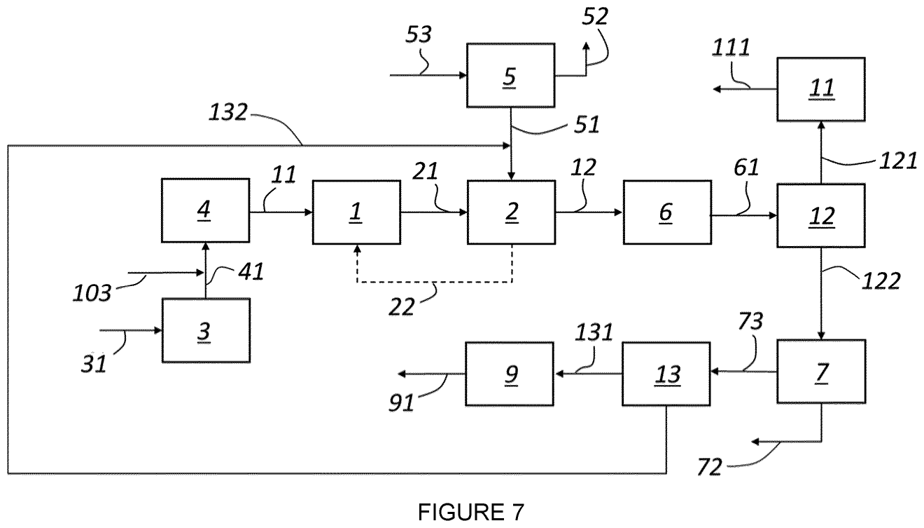

FIG. 7 shows a method for production of hydrogen from natural gas with separation of CO₂ according to embodiment Examples 5-7.

The processes in embodiment Examples 5-7 may be substantially the same, or identical, to Embodiment Example 2 except that the rest gas 132 is recycled to the ATR 2.

The oxygen feed 51 may be adjusted to secure a constant exit temperature from ATR of about 1020° C. The syngas production, by the ATR 2, GHR 1 and ASU 5, and natural gas treatment by removing sulfur 3 and pre-reforming 4, and water-gas shift 6, may be as described in FIGS. 1 and 2 with units with corresponding reference signs. Further, compression of hydrogen 11 and CO₂ 9 may be as described in FIG. 2 with corresponding reference signs. The separation of hydrogen by a Pd-membrane 12, water condensation 7 and cryogenic CO₂ separation 13 may be as described in FIG. 4 with corresponding reference signs. The only difference is that the rest gas 132 is used as recycle-gas to the ATR 2. The processes in the ATR 2 are therefore adapted so that the rest gas can additionally be received by the ATR 2.

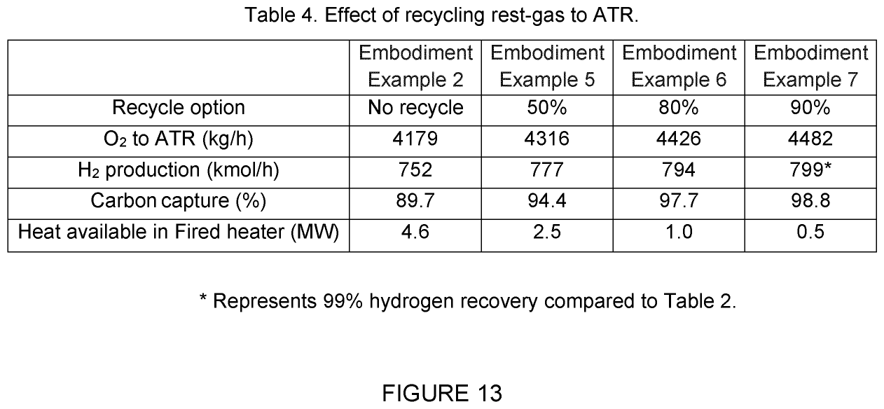

The difference between Embodiment Examples 5-7 is in the amount of rest gas that is recycled, which is detailed in Table 4 in FIG. 13.

### Comparison of Embodiment Examples 2 and 5-7

In Table 4 in FIG. 13, Embodiment Examples 5-7, with recycle of rest gas, are compared to Embodiment Example 2. Although Embodiment Example 2 shows good performance, as seen in Table 3 in FIG. 12, it is desirable to improve the efficiency of CO₂ capture and the carbon capture fraction. Embodiments achieve this by recycling at least part of the rest gas to the reformer section. The results outlined in Table 4, in FIG. 13, show a surprising effect in that much better performances are reached. Hydrogen production increases, with a recovery of 99% for Embodiment Example 7 (90% recycle), compared to 93% H₂ recovery for Embodiment Example 2 as defined in Table 2 in FIG. 11; hydrogen loss is reduced from 7% to 1%. Simultaneously, the carbon capture increases from 90% in Embodiment Example 2 to 99% in Embodiment Example 7, the best performance of all examples.

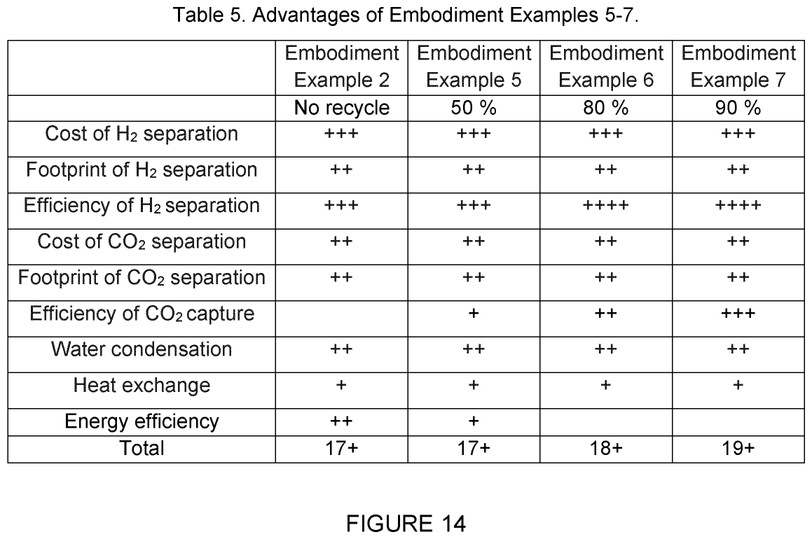

When the production and separation efficiencies increase, more oxygen is needed in the ATR and less fuel gas is available for heat generation. The advantages summarized in Table 5, in FIG. 14, indicates that a high degree of recycle is preferable. Probably more important is that a superior carbon capture fraction, as in Embodiment Example 7, is considered a decisive advantage in many hydrogen projects.

### Embodiment Example 8

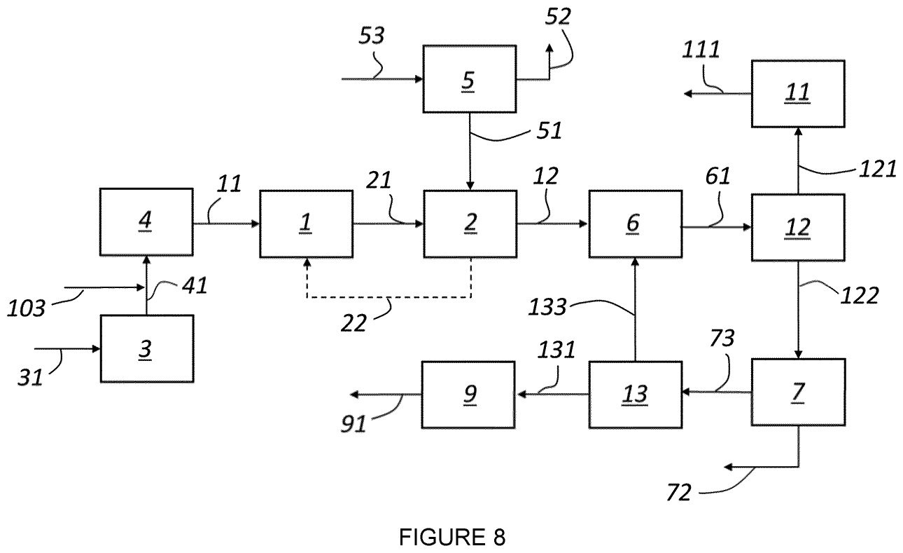

FIG. 8 shows a method for production of hydrogen from natural gas with separation of CO₂ according to Embodiment Example 8 which may be identical to Embodiment Example 2 except that the rest gas 133 from the cryogenic CO₂ separation 13 is recycled to the WGS 6. The syngas production, by the ATR 2, GHR 1 and ASU 5, and natural gas treatment by removing sulfur 3 and pre-reforming 4, and water-gas shift 6, may be as described in FIGS. 1 and 2 with units with corresponding reference signs. Further, compression of hydrogen 11 and CO₂ 9 may be as described in FIG. 2 with corresponding reference signs. Separation of hydrogen by Pd-membrane 12, water condensation 7 and cryogenic CO₂ separation may be as described in FIG. 4 with corresponding reference signs. The only difference is that the rest gas 133 is used as recycle-gas to the WGS 6. Process simulations have been made for recycle of 50%, 80% and 90% of rest gas to WGS. However, embodiments include using any feasible recycle ratio of the rest gas.

### Embodiment Example 9

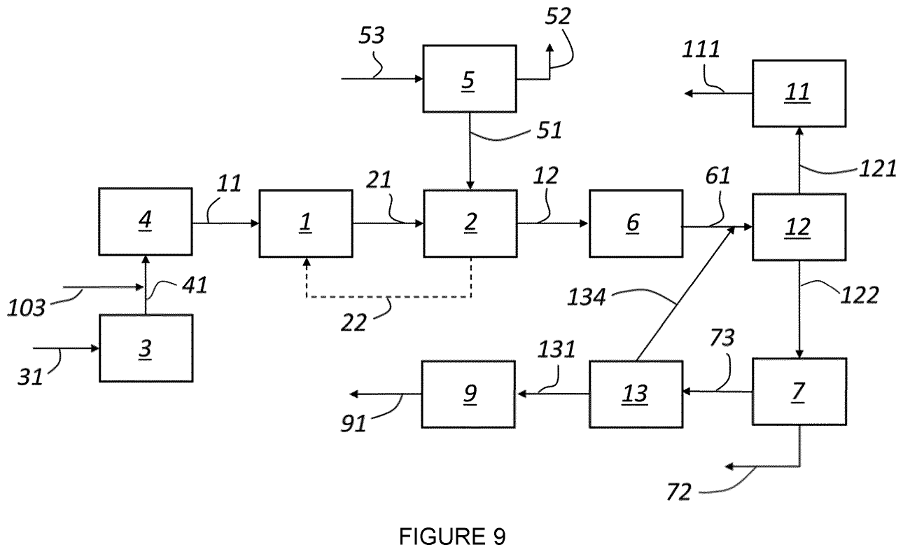

FIG. 9 shows a method for production of hydrogen from natural gas with separation of CO₂ according to Embodiment Example 9 which may be identical to Embodiment Example 2 except that the rest gas 134 from the cryogenic CO₂ separation 13 is recycled to the membrane unit 12. The syngas production, by the ATR 2, GHR 1 and ASU 5, and natural gas treatment by removing sulfur 3 and pre-reforming 4, and water-gas shift 6, may be as described in FIGS. 1 and 2 with units with corresponding reference signs. Further, compression of hydrogen 11 and CO₂ 9 may be as described in FIG. 2 with corresponding reference signs. Separation of hydrogen by the Pd-membrane 12, water condensation 7 and cryogenic CO₂ separation may be as described in FIG. 4 with corresponding reference signs. The only difference is that the rest gas 134 is used as recycle-gas to the membrane unit 12. Process simulations have been made for recycle of 50%, 80% and 90% of rest gas to the Pd-membrane. However, embodiments include using any feasible recycle ratio of the rest gas.

### Embodiment Example 10

Embodiment Example 10 is identical to Embodiment Examples 5-7 except that the oxygen feed 51 is kept constant compared to Embodiment Example 2. This reduces the exit temperature from the ATR 2 from 1020° C. to, respectively, 1008° C., 999° C., 989° C. and 974° C. for 30%, 50%, 80% and 90% recycle.

### Comparison of Embodiment Examples 2, 6, 8, 9 and 10

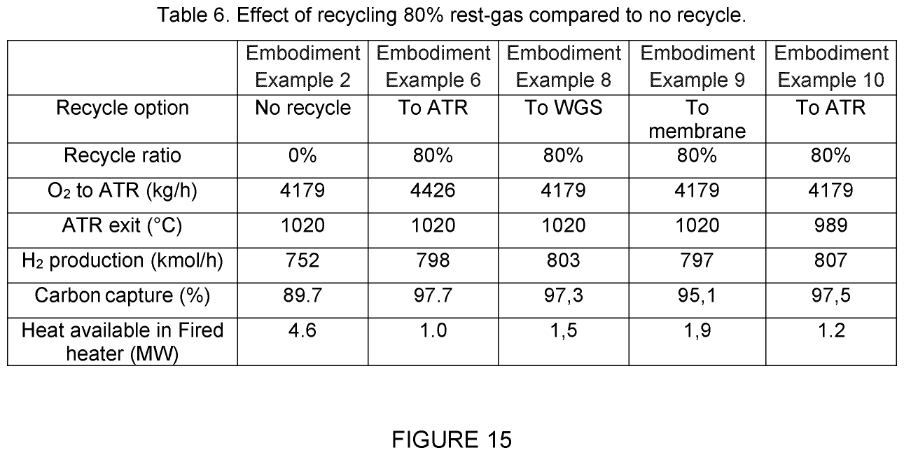

Table 6, in FIG. 15, summarizes 80% recycle of rest gas from CO₂ separation compared to no recycle. The recycle is to the ATR, WGS and Pd-membrane respectively. For recycle to ATR, the oxygen feed has been increased in Embodiment Example 6 to keep the exit temperature constant. The following surprising advantageous effects are found:
Hydrogen production increases significantly for all recycle cases.
Carbon capture rate increases significantly for all recycle cases.
Very high capture rates are obtained when recycle is to ATR or WGS.
Recycle to ATR without increasing oxygen flow is beneficial.
More energy for fired heater is available when recycle is to Pd-membrane.

### Embodiment Example 11

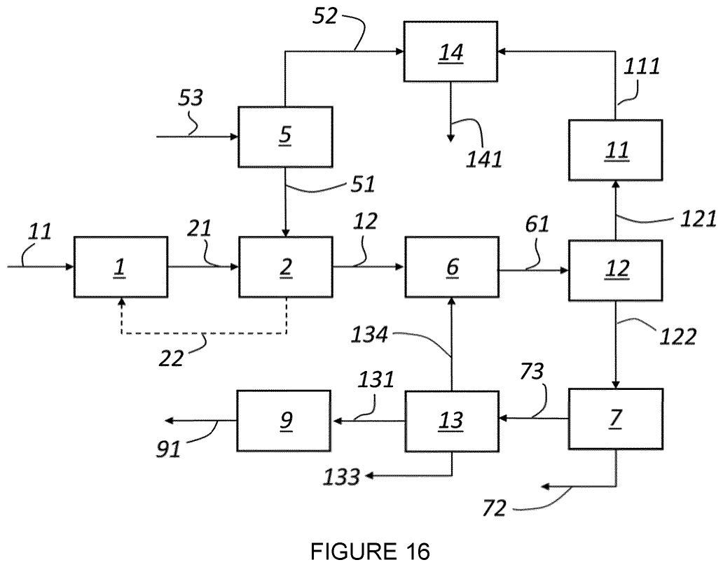

FIG. 16 shows a system according to Embodiment Example 11.

Embodiment Example 11 is directed towards producing ammonia 141 and is similar to all previous Embodiment Examples in that a Pd-membrane 12 is used to separate hydrogen, the syngas is produced by a combination of GHR 1 and ATR 2, and there is a WGS reactor(s) 6.

In the present embodiment, nitrogen 52, from the ASU 5, is combined with hydrogen, from the membrane separator 12, in an ammonia synthesis unit 14. The hydrogen supplied to the ammonia synthesis unit 14 may be either hydrogen stream 121 or the compressed hydrogen stream 111.

A preferred implementation of the present embodiment is shown in FIG. 16. This is similar to Embodiment Example 8 and has corresponding reference signs. However, embodiments also include alternatively generating the hydrogen supply using any of the other Embodiment Examples described herein, and using any recycle ratios of rest gas.

Advantages of using systems according to the present embodiment for the production of ammonia include, but are not limited to, efficient natural gas reforming by using GHR/ASU, one-step WGS reaction, hydrogen separation at the same temperature as WGS, ease of separating CO₂ by cryogenic cooling, high hydrogen productivity and low CO₂ emission by recycle of rest gas, and low content of inerts in the ammonia synthesis loop.

### Embodiment Example 12

The present embodiment is directed towards providing performance gains by recycling the rest gas that remains after the hydrogen and CO₂ separation processes.

In the present embodiment, the hydrogen separation process may be performed before the CO₂ separation process, and the rest gas is therefore the gas remaining after the CO₂ separation process. The present embodiment also includes an alternative implementation in which the CO₂ separation process is performed before the hydrogen separation process, and the rest gas is therefore the gas remaining after the hydrogen separation process.

The rest gas may be fed back into one or more of any of the processes performed in the hydrogen production process. For example, the rest gas may be fed back into one or more reforming process, water-gas-shift process, hydrogen separation process and CO₂ separation process.

All of the rest gas may be recycled by feeding it back into one or more or the processes performed in the hydrogen production process. Alternatively, only a portion of the rest gas may be recycled. The portion of the rest gas that is recycled may be at least 50%, preferably at least 80%, and more preferably at least 90%.

In the present embodiment, any reforming process may be used. In particular, the reforming process may only comprise an autothermal reforming process.

In the present embodiment, any hydrogen separation process and CO₂ separation process may be used. In particular, the hydrogen separation process may be a PSA process. The CO₂ separation process may be a cryogenic process.

In the present embodiment, the hydrogen separation process is not restricted to being performed before the CO₂ separation process. Embodiments include the CO₂ separation process alternatively being performed before the hydrogen separation process and the rest gas being the remaining gas following the hydrogen separation process. Some, or all, of the rest gas may be recycled as described above.

The embodiments presented throughout the present document provide advantageous methods and systems for the production of hydrogen and/or ammonia. In particular, the use of a Pd-membrane to separate hydrogen immediately downstream of a WGS reactor has a surprising synergistic effect. Contrary to known techniques, the WGS reactor may be operated at substantially the same temperature as the Pd-membrane. The WGS reactor may be operated under conditions that are more preferable for the effective operation of the Pd-membrane and this can substantially improve the overall efficiencies and effectiveness of the system.

In a particularly preferred implementation according to an embodiment, the hydrogen separation process uses a hydrogen separation device as disclosed in the published patent application WO2020/012018A1, the entire contents of which are incorporated herein by reference. The hydrogen separation device disclosed in WO2020/012018A1 uses Pd-membranes to separate hydrogen from a gas mixture. The operational capabilities of the hydrogen separation device disclosed in WO2020/012018A1 result in it being particularly suitable for use in the hydrogen and/or ammonia production processes according to embodiments.

Other particularly advantageous techniques that may be used in methods and systems according to embodiments are the recycling of the rest gas directly to the Pd-membrane separator and/or water gas shift (WGS) reactor.

Embodiments include a number of modifications and variations to the above described techniques.

Embodiments may use a Pd-membrane separator 12 to separate hydrogen from shifted gas. Optionally, a sweep gas may be used on the permeate side of the membrane. The sweep gas may be steam. The steam may be at an elevated total pressure above 5 bar, preferably above 10 bar.

Embodiments include the use of a water separator, such as a condenser, in between the Pd-membrane separator 12 and the hydrogen compressor 11 to separate hydrogen from the used sweep gas.

Embodiments also include optionally using a sweep gas on the retentate side of the membrane.

In embodiments, a) sulfur may be removed from the feed gas, b) the feed gas may be saturated with water, c) hydrogen may optionally be added to the gas stream before pre-reforming the gas that has been subject to treatments a and b, d) the gas from c may be reformed by a combination of gas-heated reforming and autothermal reforming, e) the reformed gas may be subjected to water-gas-shift to give a shifted gas, f) hydrogen may be separated from the shifted gas using a Pd-membrane, g) carbon dioxide may be separated from the shifted gas that has been subject to treatment f, h) the separated hydrogen is optionally compressed and liquefied, i) the separated carbon dioxide is optionally compressed and liquefied.

In embodiments, at least part of the rest gas from separating hydrogen and carbon dioxide may be recycled.

In embodiments, the portion of the rest gas that is recycled may be more than 50%, preferably around 80%, more preferably at least 90%. Embodiments include all of the rest being recycled.

In embodiments, the rest gas that is recycled may be fed back into the gas-heated reforming process.

In embodiments, the rest gas that is recycled may be fed back into the autothermal reformer, the water-gas-shift reactor(s) and/or the Pd-membrane.

In embodiments, the feed gas may be natural gas.

In embodiments, the feed gas may be a hydrocarbon rich gaseous stream from or within an oil refinery, or a petrochemical plant.

In embodiments, the gas-heated reformer may be heated by the exit gas from an autothermal reformer.

In embodiments, the exit temperature of the reformed gas from the gas-heated reformer may be in the range 400-800° C., preferably 450-700° C., more preferably 540-600° C.

In embodiments, the autothermal reformer may be supplied with oxygen from an air separation unit.

In embodiments, the autothermal reformer may be supplied with oxygen or oxygen enriched air from a membrane air separation unit.

In embodiments, the water-gas-shift reaction may be conducted in a high-temperature-shift and a low-temperature shift reactor.

In embodiments, the water-gas-shift reaction may be conducted in one reactor.

In embodiments, the water-gas shift reactor may be operated at a temperature between 200 and 300° C., preferably between 240 and 270° C.

In embodiments, the water-gas shift reactor may be operated at a temperature between 270 and 330° C., preferably between 290 and 310° C., most preferably at about 300° C.

In embodiments, no additional steam may be added between the reformer and the WGS-reactor.

In embodiments, the water-gas shift reactor may utilize a Cu-based catalyst.

In embodiments, the CO conversion in the WGS reactor may be at least 90%, but below 98%, more preferably below 96%.

In embodiments, hydrogen may be separated before CO₂ is separated from the shifted gas.

In embodiments, the WGS and the Pd-membrane may be operated at about the same temperature.

In embodiments, water may be separated after the Pd-membrane and not before the membrane.

In embodiments, the Pd-membrane may be operated at a temperature between 200 and 400° C., preferably between 250 and 350° C., more preferably between 270 and 330° C.

In embodiments, carbon dioxide may be separated cryogenically. The carbon dioxide may be deposited in a geological reservoir.

In embodiments, optionally some, or all, of the heat required for operating any of the processes may be provided by a nearby processing plant.

In embodiments, optionally some, or all, of the heat required for operating any of the processes may be provided by electricity from the grid and/or electricity from renewable energy source(s).

In embodiments, nitrogen may be produced by the air separation unit.

In embodiments, nitrogen and hydrogen may be used to produce ammonia. In embodiments, methanisation may be substantially avoided in the ammonia synthesis.

Embodiments include the following numbered clauses:
1. A method of producing hydrogen, the method comprising:
   receiving a feed gas comprising hydrocarbons;
   performing reforming processes on the feed gas so as to generate a reformed gas comprising hydrogen and carbon monoxide, wherein
      the reforming processes comprise both a gas-heated reforming process and an autothermal reforming process, and
      heat generated by the autothermal reforming process is supplied to the gas-heated reforming process;
   performing a water-gas-shift process on the reformed gas so as to generate a shifted gas comprising hydrogen and carbon dioxide;
   performing a hydrogen separation process to thereby generate hydrogen and a hydrogen-depleted shifted gas; and
   performing a carbon dioxide separation process on the hydrogen-depleted shifted gas to thereby generate carbon dioxide;
   wherein the hydrogen separation process comprises:
      inputting the shifted gas to a hydrogen separator that comprises a Palladium membrane, wherein the hydrogen separator comprises a permeate side of the Palladium membrane and a retentate side of the Palladium membrane, and the shifted gas is input to the retentate side of the Palladium membrane;
      outputting hydrogen from the permeate side of the Palladium membrane; and
      outputting hydrogen-depleted shifted gas from the retentate side of the Palladium membrane.
2. The method according to clause 1, further comprising performing a sulfur removal process on the feed gas before performing the reforming processes on the feed gas.
3. The method according to clause 1 or 2, further comprising performing a pre-reforming process on the feed gas before performing the reforming processes on the feed gas; and
   the method further comprising:
   optionally saturating the feed gas with at least water before performing the pre-reforming processes on the feed gas; and
   optionally adding hydrogen to the feed gas before performing the pre-reforming processes on the feed gas.
4. The method according to any of the preceding clauses, wherein the carbon dioxide separation process generates carbon dioxide and a rest gas, and the method further comprises recycling at least part of the rest gas by feeding at least part of the rest gas back into one of said performed processes in the method of producing hydrogen.
5. The method according to clause 4, wherein the portion of the rest gas that is recycled is at least 50%, preferably at least 80%, and more preferably at least 90%.
6. The method according to clause 4 or 5, wherein the rest gas that is recycled is fed back into the autothermal reforming process.
7. The method according to clause 4 or 5, wherein the rest gas that is recycled is fed back into the water-gas-shift process.
8. The method according to clause 4 or 5, wherein the rest gas that is recycled is fed back into the hydrogen separation process.
9. The method according to any of the preceding clauses, wherein the feed gas is natural gas.
10. The method according to any of the preceding clauses, wherein the feed gas is a hydrocarbon-rich gaseous stream from, or within, an oil refinery or a petrochemical plant.
11. The method according to any of the preceding clauses, wherein the temperature of the gas exiting the gas-heated reforming process is in the range 400-800° C., preferably 450-700° C., more preferably 540-600° C.
12. The method according to any of the preceding clauses, wherein the autothermal reforming process is supplied with oxygen from an air separation unit.
13. The method according to any preceding clause, wherein the water-gas-shift process is conducted in one water-gas-shift reactor.
14. The method according to clause 13, wherein the water-gas shift reactor is operated at a temperature between about 200 and about 330° C., preferably between about 240 and about 310° C., such as between about 240 and about 270° C. or between about 290 and about 310° C., and/or at about 300° C.
15. The method according to any of the preceding clauses, wherein the water-gas-shift process and the hydrogen separation process are operated at about the same temperature.
16. The method according to any of the preceding clauses, wherein no additional steam is added between the reforming processes and the water-gas-shift process.
17. The method according to any of the preceding clauses, wherein the water-gas-shift process comprises using a Cu-based catalyst.
18. The method according to any of the preceding clauses, further comprising operating the water-gas shift process so that the CO conversion in the water-gas-shift process is at least 90%, and below 98%, more preferably below 96%.
19. The method according to any of the preceding clauses, wherein water is separated from the hydrogen-depleted shifted gas output from the hydrogen separation process.
20. The method according to any of the preceding clauses, wherein water is not separated from the shifted gas before the hydrogen separation process.
21. The method according to any of the preceding clauses, wherein the Palladium membrane is operated at a temperature between 200 and 400° C., preferably between 250 and 350° C., more preferably between 270 and 330° C.
22. The method according to any of the preceding clauses, wherein the carbon dioxide separation process is conducted cryogenically.
23. The method according to clause 12, or any clause dependent thereon, wherein the air separation unit is also arranged to generate nitrogen, and the method comprises generating ammonia in dependence on nitrogen output from the air separation unit and hydrogen output from the hydrogen separation process.
24. A hydrogen production plant arranged to perform the method of any of clauses 1 to 22.
25. An ammonia production plant arranged to perform the method of clause 23.

The flow charts and descriptions thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1. A method of producing hydrogen, the method comprising:
receiving a feed gas comprising hydrocarbons;
performing one or more reforming processes on the feed gas so as to generate a reformed gas comprising hydrogen and carbon monoxide;
performing a water-gas-shift process on the reformed gas so as to generate a shifted gas comprising hydrogen and carbon dioxide;
performing a hydrogen separation process and a carbon dioxide separation process on the shifted gas to thereby generate separate streams of hydrogen, carbon dioxide and a rest gas; and
the method further comprises recycling at least part of the rest gas by feeding at least part of the rest gas back into one or more the water-gas-shift process, the hydrogen separation process and the carbon dioxide separation process;
wherein the portion of the rest gas that is recycled is at least 80%, and more preferably at least 90%.

2. The method according to claim 1, wherein the reforming process comprises an autothermal reforming process and/or a partial oxidation reforming process.

3. (canceled)

4. The method according to claim 1, wherein the reforming process comprises both a gas-heated reforming process and an autothermal reforming process; and
heat generated by the autothermal reforming process is supplied to the gas-heated reforming process.

5. The method according to claim 1, further comprising:
optionally performing a sulfur removal process on the feed gas before performing the reforming process on the feed gas; and
optionally performing a pre-reforming process on the feed gas before performing the reforming processes on the feed gas;
wherein the pre-reforming process comprises:
optionally saturating the feed gas with at least water before performing the pre-reforming processes on the feed gas; and
optionally adding hydrogen to the feed gas before performing the pre-reforming processes on the feed gas.

6. The method according to claim 1, wherein the hydrogen separation process comprises:
inputting the shifted gas to a hydrogen separator that comprises a Palladium membrane, wherein the hydrogen separator comprises a permeate side of the Palladium membrane and a retentate side of the Palladium membrane, and the shifted gas is input to the retentate side of the Palladium membrane;
outputting hydrogen from the permeate side of the Palladium membrane; and
outputting a hydrogen-depleted shifted gas from the retentate side of the Palladium membrane,
wherein the Palladium membrane is operated at a temperature between 200 and 400° C., preferably between 250 and 350° C., more preferably between 270 and 330° C.

7. The method according to claim 1, wherein the hydrogen separation process comprises a PSA process.

8-10. (canceled)

11. The method according to claim 1, wherein the feed gas is natural gas.

12. The method according to claim 1, wherein the feed gas is a hydrocarbon-rich gaseous stream from, or within, an oil refinery or a petrochemical plant.

13. The method according to claim 1 wherein the reforming process comprises a gas-heated reforming process and the temperature of the gas exiting the gas-heated reforming process is in the range 400-800° C., preferably 450-700° C., more preferably 540-600° C.

14. The method according to claim 1, wherein the one or more reforming processes are supplied with oxygen from an air separation unit.

15. The method according to claim 1, wherein the water-gas-shift process is conducted in one water-gas-shift reactor;
wherein, optionally, the water-gas shift reactor is operated at a temperature between about 200 and about 330° C., preferably between about 240 and about 310° C., such as between about 240 and about 270° C. or between about 290 and about 310° C., and/or at about 300° C.; and
wherein, optionally, the water-gas-shift process comprises using a Cu-based catalyst.

16. The method according to claim 1, wherein the water-gas-shift process and the hydrogen separation process are operated at about the same temperature.

17. The method according to claim 1, wherein no additional steam is added between the reforming processes and the water-gas-shift process.

18. The method according to claim 1, further comprising operating the water-gas shift process so that the CO conversion in the water-gas-shift process is at least 90%, and below 98%, more preferably below 96%.

19. The method according to claim 1, wherein water is separated from hydrogen-depleted shifted gas output from the hydrogen separation process.

20. The method according to claim 1, wherein water is not separated from the shifted gas before the hydrogen separation process.

21. (canceled)

22. The method according to claim 1, wherein the carbon dioxide separation process is conducted cryogenically.

23. The method according to claim 1, the method further comprising generating ammonia in dependence on hydrogen output from the hydrogen separation process and nitrogen output from an air separation unit.

24. A hydrogen production plant arranged to perform a method of producing hydrogen, the method comprising:
receiving a feed gas comprising hydrocarbons;
performing one or more reforming processes on the feed gas so as to generate a reformed gas comprising hydrogen and carbon monoxide;
performing a water-gas-shift process on the reformed gas so as to generate a shifted gas comprising hydrogen and carbon dioxide;
performing a hydrogen separation process and a carbon dioxide separation process on the shifted gas to thereby generate separate streams of hydrogen, carbon dioxide and a rest gas; and
recycling at least part of the rest gas by feeding at least part of the rest gas back into one or more the water-gas-shift process, the hydrogen separation process and the carbon dioxide separation process;
wherein the portion of the rest gas that is recycled is at least 80%, and more preferably at least 90%.

25. An ammonia production plant arranged to perform a method of producing ammonia, the method comprising:
receiving a feed gas comprising hydrocarbons;
performing one or more reforming processes on the feed gas so as to generate a reformed gas comprising hydrogen and carbon monoxide;
performing a water-gas-shift process on the reformed gas so as to generate a shifted gas comprising hydrogen and carbon dioxide;
performing a hydrogen separation process and a carbon dioxide separation process on the shifted gas to thereby generate separate streams of hydrogen, carbon dioxide and a rest gas;
recycling at least part of the rest gas by feeding at least part of the rest gas back into one or more the water-gas-shift process, the hydrogen separation process and the carbon dioxide separation process;
wherein the portion of the rest gas that is recycled is at least 80%, and more preferably at least 90%; and
generating ammonia in dependence on hydrogen output from the hydrogen separation process and nitrogen output from an air separation unit.
